(19) United States
(12) Patent Application Publication
(10) Pub. No.: US 2015/0288937 A1
(43) Pub. Date: Oct. 8, 2015

(54) PROJECTION DEVICE

(71) Applicant: LITE-ON TECHNOLOGY CORPORATION, Taipei (TW)

(72) Inventors: Fu-Ji TSAI, Taipei (TW); Liang-Tang CHEN, Taipei (TW)

(73) Assignee: LITE-ON TECHNOLOGY CORPORATION, Taipei (TW)

(21) Appl. No.: 14/675,153

(22) Filed: Mar. 31, 2015

(30) Foreign Application Priority Data
Apr. 3, 2014 (CN) 201410133529.0

(51) Int. Cl. H04N 9/31; G02B 5/04; G02B 5/30; G02B 27/28

(52) U.S. Cl. CPC H04N 9/3167; H04N 9/3161; H04N 9/3164; G02B 27/283; G02B 5/04; G02B 5/3083

(57) ABSTRACT

A projection device is provided. The projection device includes a first laser source, a second laser source, a beam combiner, and an imaging unit. The first laser source emits a first light beam. The second laser source emits a second light beam. The beam combiner is made of a birefringent material and has a light receiving surface. The first and second light beams enter the light receiving surface. The first and second light beams are combined into a combined light beam after passing through the beam combiner. The imaging unit processes the combined light beam to generate a projection image.

This application claims the benefit of People's Republic of China application Serial No. 201410133529.0, filed Apr. 3, 2014, the subject matter of which is incorporated herein by reference.

### FIELD OF THE INVENTION

The present invention relates to a projection device, and more particularly, to a projection device including a beam combiner.

### BACKGROUND OF THE INVENTION

It has become a major technology development trend to integrate various functions and applications on a portable device, such as a mobile phone. Micro projection system is one of the applications. A micro projection system may be integrated on a portable device to project image messages for facilitating personal applications, such as playing video clips and browsing websites, or enabling social activities, such as meetings and conference calls. Due to the features of miniaturization, portability, and low power consumption, micro projection system has fulfilled multiple kinds of daily life needs. However, a micro projection system with even smaller size becomes more and more important in response to future trends and user requests. Thus there is a need for integration and design miniaturization of optical systems within a projection device.

### SUMMARY OF THE INVENTION

The disclosure is directed to a projection device. One of the advantages of the proposed projection device is reduced hardware cost.

In an embodiment, a projection device is provided. The projection device includes a first laser source, a second laser source, a beam combiner, and an imaging unit. The first laser source emits a first light beam. The second laser source emits a second light beam. The beam combiner is made of a birefringent material and has a light receiving surface. The first and second light beams enter the light receiving surface. The first and second light beams are combined into a combined light beam after passing through the beam combiner. The imaging unit processes the combined light beam to generate a projection image.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 illustrates a diagram of a projection device according to the first embodiment of the invention.

FIG. 2 illustrates a diagram of a projection device according to the second embodiment of the invention.

FIG. 3 illustrates a diagram of a projection device according to the third embodiment of the invention.

FIG. 4 illustrates a diagram of a projection device according to the fourth embodiment of the invention.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION OF PREFERRED EMBODIMENTS

A laser projection system relies on parallel light beams from red, green and blue laser sources to be collimated or focused to generate an image light beam. If red, green and blue laser sources are independent and separate, such as three independent semiconductor laser devices, three filters and three collimators are required to combine light beams emitted from different laser sources. Each filter and each collimator may correspond to one of the three colors of the laser source. In this example, the required extra optical elements make the entire optical system large in volume.

In order to reduce the size of laser sources, multi-chip package of laser diodes may be adopted. Multiple laser diodes are arranged in an array in a single package, and the distance between each of the laser sources may be within the range of 0.1 mm-1 mm, such as 110 μm. Because the distance between laser sources is so small that collimating or focusing parallel laser beams may be difficult. For instance, if a single collimator is used for all the laser sources within a multi-chip package, different laser sources in the array may result in multiple light spots after passing through the single collimator. In order to overcome the above mentioned difficulty, additional beam splitter, filter, and collimator may be required to perform beam splitting on multiple laser sources within a multi-chip package and then combine the split beams into a collimated light beam. However such approach increases the number of optical elements and hence the system volume, which loses the advantage of multi-chip package of being small in volume.

A projection device is proposed in this disclosure. The projection device includes a beam combiner made of a birefringent material. The beam combiner is capable of combining light beams from different laser sources into a combined light beam. Therefore the volume of the entire optical system can be reduced, taking advantage of high energy density and small size of semiconductor laser devices. In this disclosure, at least one characteristic parameter of the beam combiner is corresponding to at least one light beam parameter of different laser sources. The detailed description of various embodiments is given below.

### The First Embodiment

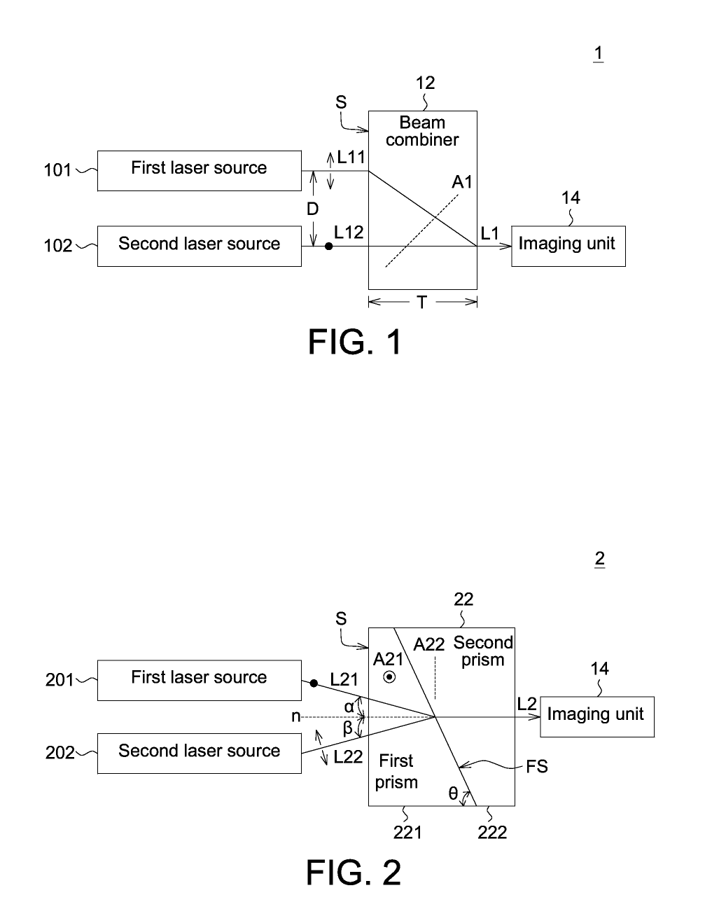

FIG. 1 illustrates a diagram of a projection device according to the first embodiment of the invention. The projection device 1 includes a first laser source 101, a second laser source 102, a beam combiner 12, and an imaging unit 14. The first laser source 101 emits a first light beam L11. The second laser source 102 emits a second light beam L12. The beam combiner 12 is made of a birefringent material and has a light receiving surface S. The first light beam L11 and the second light beam L12 enter the light receiving surface S. The first light beam L11 and the second light beam L12 are combined into a combined light beam L1 after passing through the beam combiner 12. The imaging unit 14 processes the combined light beam L1 to generate a projection image.

The first laser source 101 may be for example a red light laser, and the second laser source 102 may be for example a blue light laser. In another example, the first laser source 101 and the second laser source 102 may be of the same color, such as both being red light lasers. The first laser source 101 and the second laser source 102 may be laser diodes.

The polarization direction of the first light beam L11 is perpendicular to the polarization direction of the second light beam L12. As the example shown in FIG. 1, the polarization direction of the first light beam L11 is parallel to a beam progressing plane. The beam progressing plane is a plane defined by the progressing direction of the first light beam L11 and the progressing direction of the second light beam L12 before entering the beam combiner 12. In FIG. 1, the beam progressing plane is parallel to the paper surface. The first light beam L11 is p-polarized. The polarization direction of the second light beam L12 is normal to the beam progressing plane. The second light beam L12 is s-polarized. FIG. 1 shows the polarization directions of the first light beam L11 and the second light beam L12 (a solid dot represents the polarization direction normal to the paper surface).

The polarization direction of the first light beam L11 may be perpendicular to the polarization direction of the second light beam L12 by means of rotating a polarizer (for example, rotating 90°) in front of one of the first laser source 101 and the second laser source 102, disposing a waveplate (for example, a half-wave plate) in front of one of the first laser source 101 and the second laser source 102, or birefringent coating an exit facet of one of the first laser source 101 and the second laser source 102.

The distance between the first laser source 101 and the second laser source 102 is the light source spacing D. The light source spacing D may be for example 110 μm in a multi-chip package. In this embodiment, both the progressing directions of the first light beam L11 and the second light beam L12 before entering the beam combiner 12 are parallel to the normal line to the light receiving surface S, which is the left edge of the beam combiner 12 shown in FIG. 1. The beam combiner 12 may be for example a rectangular cuboid, and hence the left edge of the beam combiner 12 is the light receiving surface S that receives light beams emitted from laser sources.

The beam combiner 12 is made of a birefringent material. The birefringent material may be for example calcite (CaCO₃) or rutile (TiO₂). Due to the characteristics of the birefringent material, when the first light beam L11 and the second light beam L12 (with polarization direction perpendicular to that of the first light beam L11) pass through the beam combiner 12, the refraction index as well as the traveling direction will be different for the first light beam L11 and the second light beam L12. As can be seen in FIG. 1, by adjusting the thickness T of the beam combiner 12 appropriately, the first light beam L11 and the second light beam L12 may be combined into a combined light beam L1.

The angle between the optical axis A1 of the birefringent material of the beam combiner 12 and the normal line to the light receiving surface S is corresponding to the wavelength of the incident light beam. In this embodiment, the angle between the optical axis A1 and the normal line to the light receiving surface S may be 45°. In addition, the optical axis A1, the first light beam L1, and the second light beam L2 may be coplanar. The direction of the optical axis A1 is shown in FIG. 1.

In this embodiment, the characteristic parameter of the beam combiner 12 may be the thickness T. The light beam parameter of different laser sources may be the light source spacing D. In implementation, the thickness T of the beam combiner 12 may be adjusted according to the light source spacing D of the multi-chip package, or alternatively, the light source spacing D of the multi-chip package may be adjusted according to the thickness T of the beam combiner 12.

In this embodiment, the thickness T of the beam combiner 12 is corresponding to the light source spacing D. The thickness T may be preferably within the range of 1 mm-2 mm, and the light source spacing D may be preferably within the range of 0.1 mm-0.25 mm correspondingly.

The imaging unit 14 processes the combined light beam L1 to generate a projection image. The imaging unit 14 may include a light collimator, such that the combined light beam L1 can be collimated or focused by the light collimator. Light beams from different laser sources are combined into the combined light beam L1 after passing through the beam combiner 12, and therefore only one light collimator is needed for collimation or focusing in the imaging unit 14. The hardware area and cost can thus be saved. The imaging unit 14 may further include a scanning mirror. The scanning mirror reflects the combined light beam L1 to generate the projection image by means of scanning. The scanning mirror may be for example MEMS (micro electro mechanical system) scanning mirror. The projection device 1 may be for example a micro laser projector.

### The Second Embodiment

FIG. 2 illustrates a diagram of a projection device according to the second embodiment of the invention. In the projection device 2, the first laser source 201 emits the first light beam L21, and the second laser source 202 emits the second light beam L22. The first laser source 201 and the second laser source 202 may be of the same or different color. The polarization direction of the first light beam L21 is perpendicular to the polarization direction of the second light beam L22. The angle between the progressing direction of the first light beam L21 before entering the beam combiner 22 and the normal line n of the light receiving surface S of the beam combiner 22 is the first angle α. The angle between the progressing direction of the second light beam L22 before entering the beam combiner 22 and the normal line n of the light receiving surface S of the beam combiner 22 is the second angle β. The first light beam L21 and the second light beam L22 are at different sides of the normal line n.

The beam combiner 22 includes a first prism 221 and a second prism 222. Both the first prism 221 and the second prism 222 are made of birefringent materials. The first prism 221 and the second prism 222 may use the same kind of birefringent material. For example, the beam combiner 22 may be formed by joining two pieces of calcite or joining two pieces of rutile.

In this embodiment, the optical axis A21 of the first prism 221 is perpendicular to the normal line n, the optical axis A22 of the second prism 222 is perpendicular to the normal line n, and the optical axis A22 of the second prism 222 is perpendicular to the optical axis A21 of the first prism 221. The optical axis A22 of the second prism 222, the first light beam L21, and the second light beam L22 are coplanar. As shown in FIG. 2, the optical axis A21 of the first prism 221 is normal to the paper surface, while the optical axis A22 of the second prism 222 is parallel to the paper surface.

The first prism 221 and the second prism 222 are joined together at a faying surface FS. The opposite surface to the faying surface FS of the first prism 221 is the light receiving surface S. The angle between the faying surface FS and the normal line n of the light receiving surface S is the included angle θ. The magnitude of the included angle θ is corresponding to the first angle α and the second angle β. By adjusting the included angle θ appropriately, the first light beam L21 and the second light beam L22 may be combined into a combined light beam L2.

In this embodiment, the characteristic parameter of the beam combiner 22 may be the included angle 8 between the faying surface FS and the normal line n of the light receiving surface S, or alternatively, an angle between the faying surface FS and the light receiving surface S. The light beam parameters of different laser sources may be the first angle α between the progressing direction of the first light beam L21 and the normal line n and the second angle β between the progressing direction of the second light beam L22 and the normal line n. In implementation, the included angle θ of the beam combiner 22 may be adjusted according to the first angle α and the second angle β determined during the process of manufacturing the multi-chip package, or alternatively, the first angle α and the second angle β of the laser sources may be adjusted appropriately according to the included angle θ of the beam combiner 22.

In this embodiment, the included angle 8 between the faying surface FS and the normal line n to the light receiving surface S is corresponding to the first angle α between the progressing direction of the first light beam L21 and the normal line n and the second angle β between the progressing direction of the second light beam L22 and the normal line n. The included angle 8 between the faying surface FS and the normal line n may be preferably within the range of 45°-80°, and the first angle α between the progressing direction of the first light beam L21 and the normal line n may be preferably within the range of 2°-22° correspondingly, and the second angle β between the progressing direction of the second light beam L22 and the normal line n may be preferably within the range of 2°-20° correspondingly.

### The Third Embodiment

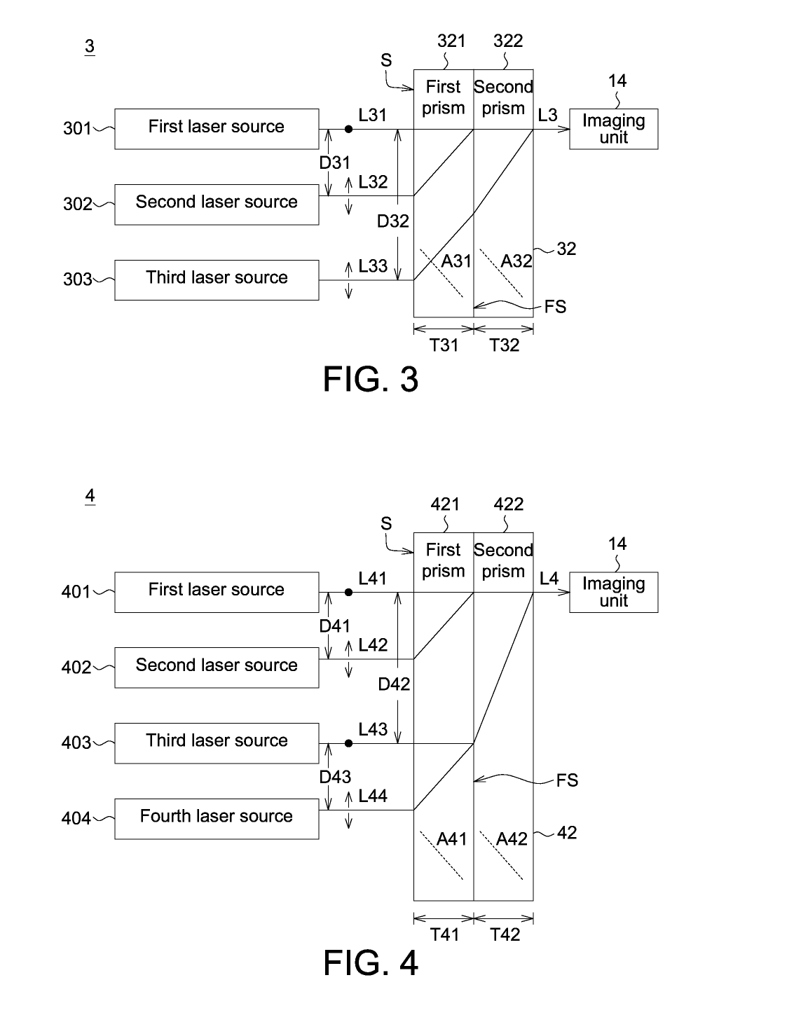

FIG. 3 illustrates a diagram of a projection device according to the third embodiment of the invention. The projection device 3 includes a first laser source 301, a second laser source 302, and a third laser source 303. The color of the first, second and third laser sources 301, 302, and 303 may be totally different, partly different, or the same. Take totally different colors for example, the first laser source 301 may be a blue light laser, the second laser source 302 may be a green light laser, and the third laser source 303 may be a red light laser. The first, second, and third light beams L31, L32, and L33 emitted from the first, second, and third laser sources 301, 302, and 303, respectively, pass through the light combiner 33 and are combined into a combined light beam L3. The polarization direction of the first light beam L31 is perpendicular to the polarization direction of the second light beam L32. The polarization direction of the third light beam L33 is perpendicular to the polarization direction of either the first light beam L31 or the second light beam L32. As for the example shown in FIG. 3, the polarization direction of the third light beam L33 is the same as that of the second light beam L32. If the three laser sources are blue, green, and red light laser, respectively, the imaging unit 14 will be able to generate a full-color image after receiving the combined light beam L3.

In this embodiment, all the progressing directions of the first, second, and third light beams L31, L32, and L33 before entering the beam combiner 32 are parallel to the normal line to the light receiving surface S. The beam combiner 32 includes a first prism 321 and a second prism 322. Both the first prism 321 and the second prism 322 are made of birefringent materials. For example, the first prism 321 and the second prism 322 may use the same kind of birefringent material. The first prism 321 and the second prism 322 are joined together at a faying surface FS. The opposite surface to the faying surface FS of the first prism 321 is the light receiving surface S. The faying surface FS may be parallel to the light receiving surface S.

The operating principles of this embodiment are similar to those in the first embodiment. The characteristic parameter of the beam combiner 32 may be the thickness T. The light beam parameter of different laser sources may be the light source spacing D. In this embodiment, the beam combiner 32 includes multiple prisms, and thus the thickness T further includes thickness of each prism and is corresponding to the light source spacing D between the laser sources that are going to be combined. As the example shown in FIG. 3, the light source spacing D31 between the first laser source 301 and the second laser source 302 is corresponding to the thickness T31 of the first prism 321. Likewise, the light source spacing D32 between the first laser source 301 and the third laser source 303 is corresponding to the thickness T32 of the second prism 322.

The angle between the optical axis A31 of the first prism 321 and the normal line to the light receiving surface S is corresponding to the wavelength of the incident light beam to the first prism 321. The angle between the optical axis A32 of the second prism 322 and the normal line to the light receiving surface S is corresponding to the wavelength of the incident light beam to the second prism 322. In this embodiment, the angle between the optical axis A31 and the normal line to the light receiving surface S may be 45°. In addition, the optical axis A31, the first light beam L31, and the second light beam L32 may be coplanar. The angle between the optical axis A32 and the normal line to the light receiving surface S may be determined by the wavelength of the incident light beam to the second prism 322.

### The Fourth Embodiment

FIG. 4 illustrates a diagram of a projection device according to the fourth embodiment of the invention. The difference between the fourth embodiment and the third embodiment is that the projection device 4 further includes a fourth laser source 404. The color of the fourth laser source 404 may be the same as that of the third laser source 403. For example, the color of the first, second, third, and fourth laser sources 401, 402, 403, and 404 may be blue, green, red, and red, respectively.

Although the color of the fourth laser source 404 may be the same as that of the third laser source 403, the wavelengths of these two laser sources may be slightly different. By deploying laser sources with same color and different wavelengths, speckle contrast can be reduced effectively. As a result, the quality of the projection image becomes better, which makes it more comfortable for a human when watching the projection image.

The fourth laser source 404 emits the fourth light beam L44, whose polarization direction is perpendicular to the polarization direction of the third light beam L43. The second laser source 402 emits the second light beam L42, whose polarization direction is perpendicular to the polarization direction of the first light beam L41. All the progressing directions of the first, second, third, and fourth light beams L41, L42, L43, and L44 before entering the beam combiner 42 are parallel to the normal line to the light receiving surface S.

The beam combiner 42 includes a first prism 421 and a second prism 422. Both the first prism 421 and the second prism 422 are made of birefringent materials. For example, the first prism 421 and the second prism 422 may use the same kind of birefringent material. The first prism 421 and the second prism 422 are joined together at a faying surface FS. The opposite surface to the faying surface FS of the first prism 421 is the light receiving surface S. The faying surface FS may be parallel to the light receiving surface S. The angle between the optical axis A41 of the first prism 421 and the normal line to the light receiving surface S is corresponding to the wavelength of the incident light beam to the first prism 421. The angle between the optical axis A42 of the second prism 422 and the normal line to the light receiving surface S is corresponding to the wavelength of the incident light beam to the second prism 422. In this embodiment, the angle between the optical axis A41 and the normal line to the light receiving surface S may be 45°. In addition, the optical axis A41, the first light beam L41, and the second light beam L42 may be coplanar. The angle between the optical axis A42 and the normal line to the light receiving surface S may be determined by the wavelength of the incident light beam to the second prism 422.

The operating principles of this embodiment are similar to those in the first and third embodiments. The light beams emitted from four laser sources can be combined into a combined light beam L4 through the design of a two-step prism structure. The characteristic parameter of the beam combiner 42 may be the thickness T. The light beam parameter of different laser sources may be the light source spacing D. In this embodiment, the beam combiner 42 includes multiple prisms, and thus the thickness T further includes thickness of each prism and is corresponding to the light source spacing D between the laser sources that are going to be combined. As the example shown in FIG. 4, the first light beam L41 and the second light beam L42 are combined by the first prism 421, the third light beam L43 and the fourth light beam L44 are also combined by the first prism 421, and the two thus combined beams are then further combined into the combined beam L4 by the second prism 422. Therefore the light source spacing D41 between the first laser source 401 and the second laser source 402 is corresponding to the thickness T41 of the first prism 421. The light source spacing D42 between the first laser source 401 and the third laser source 403 is corresponding to the thickness T42 of the second prism 422. The light source spacing D43 between the third laser source 403 and the fourth laser source 404 is corresponding to the thickness T41 of the first prism 421.

Four laser sources are included in this embodiment. However, based on the principle described above, light beams emitted from more than four laser sources may also be combined into a combined beam by the projection device provided in this disclosure.

According to the projection device disclosed herein, because the beam combiner is made of a birefringent material, light beams from different laser sources may be combined into a combined beam such that the imaging unit may generate a projected image accordingly. Whatever the number of the laser sources is, such as two to four laser sources, only one beam combiner is required to achieve the combination of light beams. Compared to a conventional approach where three filters and three collimators are needed for three visible-light laser sources, the projection device disclosed herein reduces the hardware area required by optical devices and hence saves the cost.

In addition, the projection device disclosed herein is suitable for the mechanical characteristics of the multi-chip package of the laser array, for example, the distance between laser sources greater than 0.1 mm, or small angle deviation of laser diodes. The projection device disclosed herein overcomes the difficulty of collimating or focusing light beams emitted from an array of laser sources in the multi-chip package. The size of the multi-chip package of laser diodes is small inherently, the proposed projection device also requires little hardware overhead, and therefore the projection device takes advantage of the small semiconductor laser device and achieves the goal of design miniaturization.

The projection device disclosed herein is also capable of combining four or more laser sources into a combined beam. Thus multiple laser sources with same color and different wavelength can be disposed within the projection device to reduce speckle contrast effectively and provide a better projection image quality.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A projection device, comprising:
a first laser source, emitting a first light beam;
a second laser source, emitting a second light beam;
a beam combiner, made of a birefringent material, the beam combiner having a light receiving surface; and
an imaging unit;
wherein the first light beam and the second light beam enter the light receiving surface, the first light beam and the second light beam are combined into a combined light beam after passing through the beam combiner, and the imaging unit processes the combined light beam to generate a projection image.

2. The projection device of claim 1, wherein a polarization direction of the first light beam is perpendicular to a polarization direction of the second light beam.

3. The projection device of claim 1, wherein a thickness of the beam combiner is corresponding to a light source spacing between the first laser source and the second laser source.

4. The projection device of claim 1, wherein an optical axis of the birefringent material of the beam combiner, a progressing direction of the first light beam, and a progressing direction of the second light beam are coplanar.

5. The projection device of claim 1, wherein the light combiner comprises a first prism and a second prism, the first prism and the second prism are joined together at a faying surface, and an angle between the faying surface and the light receiving surface is corresponding to a first angle and a second angle, wherein the first angle is between a progressing direction of the first light beam and a normal line to the light receiving surface, and the second angle is between a progressing direction of the second light beam and the normal line.

6. The projection device of claim 5, wherein an optical axis of the first prism is perpendicular to the normal line, an optical axis of the second prism is perpendicular to the normal line, and the optical axis of the first prism is perpendicular to the optical axis of the second prism.

7. The projection device of claim 1, further comprising a third laser source, emitting a third light beam entering the light receiving surface;
wherein the light combiner comprises a first prism and a second prism, the first prism and the second prism are joined together at a faying surface, and the faying surface is parallel to the light receiving surface;
wherein a light source spacing between the first laser source and the second laser source is corresponding to a thickness of the first prism, a light source spacing between the first laser source and the third laser source is corresponding to a thickness of the second prism;
wherein the first light beam, the second light beam, and the third light beam are combined into the combined light beam after passing through the beam combiner.

8. The projection device of claim 7, wherein an optical axis of the first prism, a progressing direction of the first light beam, and a progressing direction of the second light beam are coplanar.

9. The projection device of claim 7, further comprising a fourth laser source, emitting a fourth light beam entering the light receiving surface, a polarization direction of the fourth light beam being perpendicular to a polarization direction of the third light beam;
wherein the first light beam, the second light beam, the third light beam, and the fourth light beam are combined into the combined light beam after passing through the beam combiner.

10. The projection device of claim 9, wherein a light source spacing between the third laser source and the fourth laser source is corresponding to the thickness of the first prism.

11. The projection device of claim 1, wherein a polarization direction of the first light beam is perpendicular to a polarization direction of the second light beam by means of rotating a polarizer in front of one of the first and second laser sources, disposing a waveplate in front of one of the first and second laser sources, or birefringent coating an exit facet of one of the first and second laser sources.

12. The projection device of claim 1, wherein the first laser source and the second laser source are laser sources within a multi-chip package of laser diodes.
